(19) United States
(12) Patent Application Publication
(10) Pub. No.: US 2021/0304298 A1
(43) Pub. Date: Sep. 30, 2021

(54) Computerized Auction Platform

(71) Applicant: SAP SE, Walldorf (DE)

(72) Inventors: Nithya Rajagopalan, Bangalore (IN); Panish Ramakrishna, Bangalore (IN); Harish Dhivahar Ariharasuthan, Bangalore (IN)

(21) Appl. No.: 16/831,430

(22) Filed: Mar. 26, 2020

(51) Int. Cl. G06Q 30/08; G06K 9/62; G06N 3/08; G06F 9/54

(52) U.S. Cl. CPC G06Q 30/08; G06K 9/6257; G06F 9/542; G06N 3/08; G06K 9/6231; G06K 9/6272

(57) ABSTRACT

Various examples are directed to systems and methods for managing a computerized event platform. The computerized event platform may receive participant data describing a plurality of historical bids from a plurality of historical events and generate a set of recommended participants to participate in an event to provide a first item.

### BRIEF DESCRIPTION OF DRAWINGS

The present disclosure is illustrated by way of example and not limitation in the following figures.

FIG. 1 is a diagram showing one example of an environment including a computerized event platform configured to conduct events for items and generate sets of recommended participants

FIG. 2 is a flowchart showing one example of a process flow that can be executed by the computerized event platform of FIG. 1 to generate a set of recommended participants.

FIG. 3 is a flowchart showing one example of a process flow that can be executed by the computerized event platform of FIG. 1 to execute an event for the user.

FIG. 4 is a flowchart showing an example of a process flow that may be executed by the computerized event platform of FIG. 1 to determine a set of recommended participants.

FIGS. 5-10 are screen shots showing examples of screens of a user interface that may be provided to a user by the computerized event platform of FIG. 1.

FIG. 11 is a block diagram showing one example of a software architecture for a computing device.

FIG. 12 is a block diagram of a machine in the example form of a computing system within which instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

An example computerized event platform is programmed to conduct and administer an event on behalf of a user. The user desires to buy sell one or more items, where the items may be goods or services. The event may involve participants interacting with the event platform to provide proposals to provide and/or purchase the items. In a forward auction arrangement, the user provides one or more items for sale and the participants make interaction proposals to purchase the one or more items. In a reverse auction arrangement, the user desires to purchase one or more items and the participants are suppliers who provide proposals to supply the desired item or items to the user. In a reverse auction, the interaction proposals received from the participants describes the participants' proposals to purchase or sell the one or more items.

The interaction proposal from a participant can include a price or prices for the item or items as well as information about other terms for buying or selling the item such as, for example, when the item or items will be delivered, a maximum number of items to be supplied, etc. If the event is to provide more than one item, the interactions received from a participant may include different information (e.g., price, delivery date, etc.) for different items in the event.

The computerized event platform receives and analyzes the interaction proposals from multiple participants. The computerized event platform can also analyze participant data describing the participants. Participant data can include, for example, information about previous interaction proposals submitted by the participants, fulfillment history describing whether and how the participants have fulfilled previous orders, customer satisfaction data describing the quality of items provided by the participants, and so one. The computerized event platform is programmed to analyze the bid data and the participant data to generate a winning proposal recommendation. The winning proposal recommendation can indicate a single winning interaction proposal and/or a set of potential winning interaction proposals. For example, the user may select a winning proposal from among the set of potential winning proposals.

The computerized event platform uses significant computing resources to receive and process interaction proposal data and participant data. As described in more detail herein, this can involve complex and resource-intensive machine learning algorithms as well as other resource-hungry techniques. As a result, a computing device or devices implementing the computerized event platform will utilize significant network, data storage, and processor capacity. In many examples, a computerized event platform is arranged to execute multiple, often simultaneous, events, often for different users. This exacerbates the resource allocation challenges.

In some examples, the user selects the participants that are invited to submit interaction proposal data to the computerized event platform for an auction. Invited participants can then submit interaction proposal data, or not, according to their preference. A recurring challenge for computerized event platforms is prompting a sufficient quantity and quality of participants to submit interaction proposal data.

When invited participants fail to submit interaction proposal data the performance of the computerized event platform suffers. For example, events conducted with lower numbers of responding participants provide less confidence to the user that a winning interaction recommendation represents the best price, quality, and so on for the subject item. Also, in some examples, when invited participants fail to provide interaction proposal data, it may cause the computerized event platform to provide skewed results. For example, if higher quality participants fail to submit interaction proposal data, the computerized event platform may generate a winning interaction recommendation based on a sub-optimal balance of price, risk, and other factors. In some cases, if the number or quality of received interaction proposal data is too low, it may not be possible for the computerized event platform to generate any winning interaction recommendation. Further, in some cases, the user rejects winning interaction recommendations that are based on insufficient responses from participants.

When the computerized event platform is unable to generate a winning interaction recommendation and/or if the user is dissatisfied with the winning interaction recommendation, it is often necessary for the computerized event platform to re-execute an event, for example, with additional and/or different invited participants. Because of the resource-intensive nature of the event process, re-executing an event can bring about a significant waste of computing resources.

Further, in some examples, a large, and sometimes very large, number of participants are invited to submit interactions to the computerized event platform. This is to allow for the risk that invited participants may not submit interaction proposal data. Although inviting large numbers of participants may make it more likely that an event has a sufficient number of submitted interactions, it also increases the technical overhead for the computerized event platform. For example, the computerized event platform expends additional computing resources to provide invitations to a large number of participants. Further, if more participants than expected do submit interaction proposal data, the computerized event platform may need to process more interaction proposal data that would otherwise be necessary to conduct an effective event for the user.

Various examples address these and other challenges for computerized event platforms by utilizing techniques described herein to generate a set of recommended participants. The set of recommended participants is selected to include participants that are likely to provide interaction proposal data for an event. Some or all of the set of recommended participants is then invited to participate in the event. Because the set of recommended participants is made up of participants that are more likely to provide interaction proposal data, it increases the likelihood of receiving a robust set of interaction proposal data for evaluating the event. This can reduce the need to re-execute an event, improving the efficiency of computerized event platform and, thereby, reducing the computing resources used to perform the same task. It may also allow the computerized event platform to invite fewer participants to receive the same number of responsive interactions, thus reducing the use of computing resources to manage an event.

Various examples described herein utilize model-based clustering to generate a set of recommended participants for an event using the computerized event platform. The computerized event platform may use historical interaction proposal data to train a model. The model is configured to relate participant features to a participant vector. In some examples, the model is trained for a particular item or items that are the subject of an event. The participant vector is of a smaller dimension than the participant features. For example, the model take as input a set of X participant features and return a Y-dimensional participant vector, where Y is less than X. The computerized event platform generates participant vectors for a number of participants.

Using the participant vectors, the computerized event platform executes a clustering algorithm to generate clusters of participant vectors that are near one another in a multi-dimensional space. The number of dimensions in the multi-dimensional space may be equal to the dimension of the participant vector. One or more of the clusters is correlated to participants that are likely to submit interaction proposal data in response to an invitation to an event. The computerized event platform generates the set of recommended participants, at least in part, by selecting a set of the participant vectors that are within a threshold distance of a first cluster mean corresponding to the selected cluster. The participants corresponding to the selected participant vectors are added to the set of recommended participants for the event.

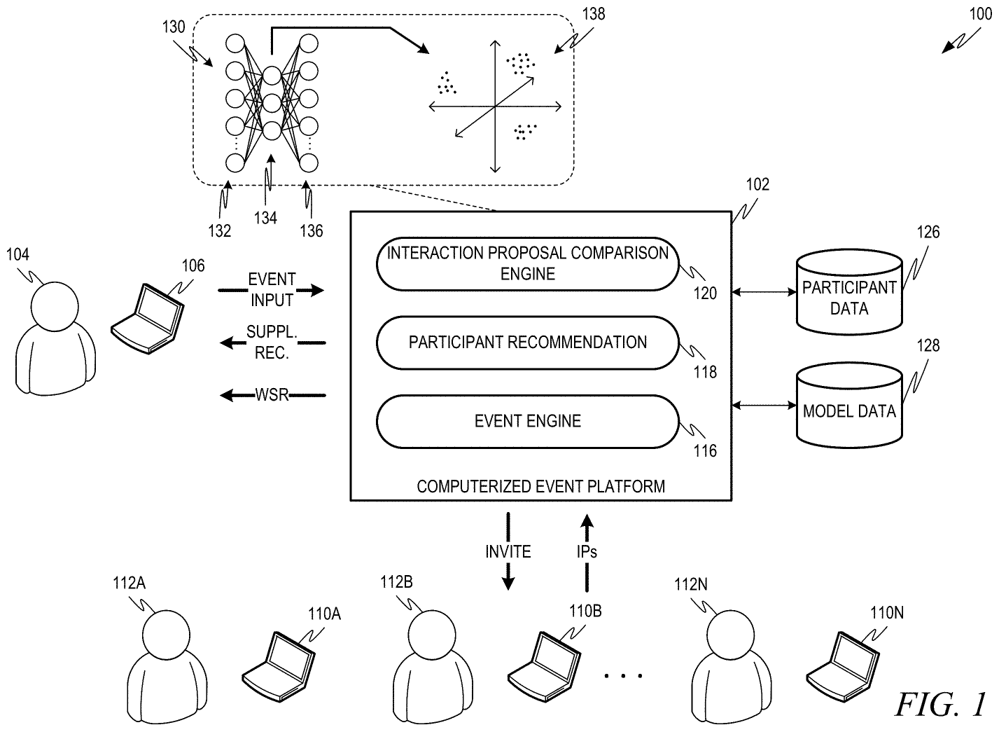

FIG. 1 is a diagram showing one example of an environment 100 including a computerized event platform 102 configured to conduct events for items and generate sets of recommended participants as described herein. The computerized event platform 102 is in communication with a user 104 and with various participants 112A, 112B, 112N. The user 104 and participants 112A, 112B, 112N utilize user computing devices 106, 110A, 110B, 110N. The user 104 and participants 112A, 112B, 112N use computing devices 106, 110A, 110B, 110N to interact with the computerized event platform 102. The computing devices 106, 110A, 110B, 110N may be or include any suitable computing devices including, for example, desktop computers, laptop computers, tablet computers, etc. The computerized event platform 102 may be or include one or more examples of any suitable computing device such as one or more servers. The computerized event platform 102 may be implemented at a single geographic location and/or distributed across multiple geographic locations. Also, in some examples, functions of the user 104 and/or participants 112A, 112B, 112N are performed by programmed computing devices without user intervention. For example, the user 104 and/or the participants 112A, 112B, 112N may be omitted.

The computerized event platform 102 is programmed to conduct events, as described herein. The computerized event platform 102 comprises a participant recommendation engine 116, an event engine 118, and an interaction comparison engine 120. The participant recommendation engine 118 generates a set of recommended participants, as described herein. The event engine 118 executes events for various items on behalf of the user 104. The interaction comparison engine 120 generates participant features and/or interaction features based on processing of interaction proposal data and/or previous participant data. The engines 116, 118, 120 can be implemented as different applications and/or different functionalities within a common application. In some examples, the engines 116, 118, 120 are implemented at different computing devices.

The interaction comparison engine 120 processes participant data 126 as well as interaction proposal data received from participants 112A, 112B, 112N to generate participant features. Participant features are descriptors of the various participants 112A, 112B, 112N, for example, based on the participants' behavior in previous events. Various example participant features that can be determined by the interaction comparison engine 120 are described herein:

Best bid portion—A best bid portion indicates the portion (e.g., a percentage) of a participant's events in which the participant provides the best interaction proposal (e.g., a highest interaction proposal for a forward event and a lowest interaction proposal for a reverse event).

Lead bid portion—A lead bid portion describes the portion (e.g., a percentage) of a participant's events in which the participant provides a lead bid. A lead bid is an interaction proposal that is within a threshold of the best interaction proposal in an event. In some examples, a lead bid is an interaction proposal with an interaction proposal price that is within a threshold percent of the best submitted interaction proposal. In other examples, a lead bid is an interaction proposal that is among the best n interaction proposals submitted for an event, wherein n can be the best 3 interaction proposals, the best 5 interaction proposals, the best 10 interaction proposals, the best 100 interaction proposals or any other suitable number. A lead bid portion participant feature can be used by the participant recommendation engine 118, for example, to allow for situations in which a participant submitted an interaction proposal that was competitive on price (e.g., a lead bid) but superior to better-priced interaction proposals for other reasons, such as risk or quality.

Participant lead price—Lead price indicates the best price that a participant has bid over an item (lead price per item) or an event including multiple items (lead price for total).

Participant lead price per item versus the participant's total lead price—This participant feature describes a comparison of the total and lead bid price when there is 100 percent participation (e.g., all invited participants submit bid data) versus when there is less than 100 percent participation.

Portion comparison of the total with respect to the lowest bid—This indicates a portion or percentage of the overall lowest bid for an item or set of items that is represented by the participant's lead price for total.

Participant term features—Participant term features describe a participant's previous interaction proposals related to terms for delivering an item or items such as, for example, transportation price, delivery lead time, etc.

Participant ranks per item—Participant ranks per item features describe the price ranking of a participant in previous events on a per item basis.

Participant ranks per rolled up cost—Participant ranks per rolled up cost describes a ranking of the participant's previous interaction proposals on rolled up costs and other incidental costs.

Participant participation—Participant participation describes a portion or percentage of events to which the participant has been invited in which the participant submitted interaction proposal data.

Participant participation for an item—This participant feature describes a portion or percentage of events where the participant has submitted an interaction proposal for a particular item compared to the total number of events to which the participant has been invited to submit an interaction proposal for the particular item.

In an event, the user 104 provides event input information to the computerized event platform 102 using the computing device 106. The event input information describes the user's desired event. For example, the event input information can include a description of the item or items that are to be the subject of the event. The event input information may also include other data about the event including, for example, event terms desired by the user (e.g., duration of the contract, delivery date, etc.).

The computerized event platform 102 receives the event input data and uses the participant recommendation engine 118 to generate a set of recommended participants for the requested event. To generate set of recommended participants, the recommendation engine 118 may train a model that relates a set of participant features to a corresponding participant vector. The participant vector may have a smaller dimension than the set of participant features. In this way, the participant recommendation engine 118 may utilize information from all or a large portion of the participant features generated by the bid comparison engine 120. The model may be trained utilizing the participant data 126 and/or participant features generated by the bid comparison engine 120.

The participant recommendation engine 118 can select the set of participant features to include one or more participant engagement features describing a participant's response to one or more previous invitations to particulate in an event. Example participant engagement features can include, for example, participation, participation for an item, etc. Utilizing participation in training the model, as described herein, causes the set of recommended participants to reflect participants who are most likely to respond to an invitation to participate in an event.

Any suitable model may be used. In some examples, the bid recommendation engine utilizes a convolutional neural network (CNN) model. For example, the CNN model may be arranged as an autoencoder. FIG. 1 shows an example representation of a CNN model 130 arranged as an autoencoder. The example CNN model 130 includes three layers 132, 134, 136. An input layer 132 includes a number of nodes. Each node may correspond to a participant feature provided as input to the CNN model 130. A second layer 134 includes fewer nodes than the input layer. An output layer 136, in some examples, includes the same number of nodes as the input layer 132. Although the example CNN model 130 includes three layers, CNN models used by the participant recommendation engine 118 in other examples can include additional layers. Also, the number of nodes in the respectively layers 132, 134, 136 may vary, for example, based on the number of participant features utilized and/or other design factors.

The participant recommendation engine 118 may train the example CNN model 130 by providing participant features as inputs to the nodes of the input layer 132 and then selecting variables at the various nodes to train the example CNN model 130 to provide the same participant features as outputs at the output layer 136. In this way, when a set of participant features is provided at the input layer 132, the participant vector is indicated by the values at the second layer 134 (or another interior layer, for example, in CNN models utilizing more than three layers). Because there are fewer nodes at the second layer 134 (or other interior layer) than there are at the input layer, the dimension of the participant vector obtained from the second layer is less than the total number of participant features utilized. Data describing the trained model can be stored, for example, at a model data store 128.

Once trained, the model is used generate participant vectors for a number of participants, for example, based on participant data 126 and/or participant features determined by the bid comparison engine 120. The participant vectors are then clustered in a multi-dimensional space. Any suitable clustering algorithm can be used to cluster the participant vectors such as, for example, a k-means technique. An example plot 138 shows clusters in a multi-dimensional space. In this example, the multi-dimensional space is a three-dimensional space, although more or fewer than three dimensions may be used.

The participant recommendation engine 118 identifies one or more of the clusters as corresponding to participants who are most favorable to the event described by the event input data provided by the user 104. For example, the participant recommendation engine 118 may classify clusters based on participant features. For example, one cluster may include participants with the best bid or lead bid. Another cluster may include participants with lower risk, and so on. The participant recommendation engine 118 selects the cluster or clusters that are most favorable, in some examples, based on the preferences of the user. For example, if the user prefers the best price, the participant recommendation engine 118 may select a cluster corresponding to participants having the most favorable features related to lead bids. On the other hand, if the user prefers lower risk, the participant recommendation engine 118 may select a cluster corresponding to participants having the most favorable features related to risk.

The participant recommendation engine 118 may then select a set of participants having participant vectors that are within a threshold distance of the cluster mean of the selected cluster in the multi-dimensional space. Any suitable technique may be used to find the distance between the cluster mean and the various participant vectors such as, for example, a Euclidean distance technique. Participants having participant vectors within the threshold distance of the cluster mean may be added to the set of recommended participants.

The set of recommended participants is provided to the user 104, for example, via the computing device 106. The user 104 may select some or all of the set of recommended participants for inviting to the event. In some examples, the participant recommendation engine 118 automatically selects some or all of the participants from the set of recommended participants for inviting to the event.

The event engine 116 sends invitations to participants 112A, 112B, 112N selected for participation in the event. In response, some or all of the selected participants 112A, 112B, 112N provide current bid data describing the participants' bids on the current event. The event engine 116 processes the bid data to determine a winning participant recommendation. The winning participant recommendation can indicate one or more of the participants 112A, 112B, 112N that provided bid data. The event engine 116, in some examples, utilizes the model and/or participant vectors to determine the winning participant recommendation. For example, the event engine 116 may consider the item and/or total price of the received bids as well as the distance of the respective participants from the cluster mean.

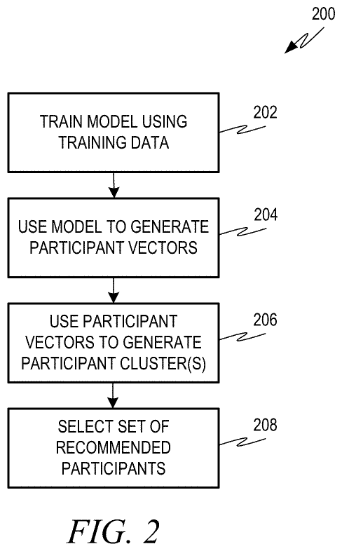

FIG. 2 is a flowchart showing one example of a process flow 200 that can be executed by the computerized event platform 102 to generate a set of recommended participants. At operation 202, the computerized event platform 102 (e.g., the participant recommendation engine 118 thereof) trains a model using training data. The training data can include participant data, including information about previous bids submitted by various participants. In some examples, as described herein, the model is a CNN or other neural network model that is trained as an autoencoder. For example, an input layer of the CNN model may have a number of nodes corresponding to a number of participant features that are to be input to the model. The output layer may have the same number of nodes. The CNN model is trained to provide outputs at the nodes of the output layer that are equivalent to the participant features provided at the input layer nodes. In some examples, the model is trained to receive participant features that relate to participant engagement and lead price, as described herein. In some examples, the model is trained for a specific item, a specific set of set of items, a specific event term, and/or a specific set of event terms. For example, participant data for training the model may be limited to participant data describing previous bids for the specific item, specific set of items, specific event term and/or specific set of event terms.

At operation 204, the computerized event platform 102 (e.g., the participant recommendation engine 118 thereof) uses the model trained at operation 202 to generate participant vectors for a set of potential participants. The set of potential participants can include any suitable set of participants. In some examples, the set of potential participants is selected by the user 104. In some examples, the set of potential participants can include incumbent participants. Incumbent participants are participants who are already part of the ecosystem of the user 104, meaning that the participants have been previously invited to participate in an event for the user 104, who has supplied the user 104 in the past, and/or have been initialized at the computerized event platform 102 to submit bids for the user 104.

In examples in which the model is a CNN or other model trained as an autoencoder, this may involve providing a set of participant feature values describing a first participant to the respective input layer nodes of the CNN model. Coefficients for a first participant vector describing the first participant are taken at an intermediate layer of the CNN model (e.g., a layer between the input layer and the output layer). The intermediate layer includes fewer nodes than the input and output layers. Accordingly, the dimension of the participant vector is less than the total number of participant features provided to the model. This process can be repeated to generate participant vectors for participants from the set of potential participants.

At operation 206, the computerized event platform 102 (e.g., the participant recommendation engine 118 thereof) uses the participant vectors to generate at least one participant cluster. The at least one participant cluster can be determined in any suitable manner. In some examples, the computerized event platform 102 (e.g., the participant recommendation engine 118 thereof) applies any suitable clustering algorithm to the participant vectors to generate one or more clusters of participants in a multi-dimensional space. The number of dimensions in the multi-dimensional space may be equal to the dimension of the participant vectors.

At operation 208, the event platform 102 (e.g., the participant recommendation engine 118 thereof) selects a set of recommended participants using the at least one cluster. For example, the event platform 102 (e.g., the participant recommendation engine 118 thereof) selects a cluster or clusters that correspond to favorable participants for an item or items that are to be the subject of an event. The selected cluster is described by a cluster mean, which is a position in the multi-dimensional space. Participants having participant vectors that are within a threshold of the cluster mean are added to the set of recommended participants.

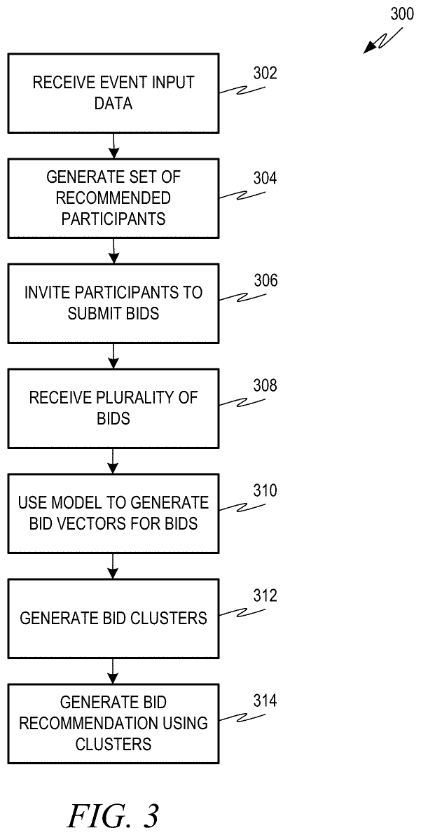

FIG. 3 is a flowchart showing one example of a process flow 300 that can be executed by the computerized event platform 102 to execute an event for the user 104. At operation 302, the computerized event platform (e.g., the event engine 116 thereof) receives event input data from the user 104 (e.g., via the computing device 106). The event input data can include, for example, data describing an item or item that are the subject of the event. As described herein, event input data can also describe a term or terms desired by the user 104.

At operation 304, the computerized event platform 102 (e.g., the participant recommendation engine 118 thereof) may generate a set of recommended participants for the event. This can be performed, for example, as described herein with respect to FIG. 2. At operation 306, the computerized event platform 102 (e.g., the event engine 116 thereof) invites some or all of the set of recommended participants to submit bids for the requested event. In some examples, the computerized event platform 102 selects the participants to be invited. In other examples, the computerized event platform 102 provides the set of recommended participants to the user 104 and the user 104 selects the participants that will be invited to submit bids at the event.

At operation 308, the computerized event platform 102 (e.g., the event engine 116 thereof) receives bid data from one or more participants 112A, 112B, 112N that were invited to submit bids. The bid data can include, for example, one or more item prices, a total bid price, and bid term data describing terms proposed by the various participants 112A, 112B, 112N. The bid term data may or may not be the same as the event term data requested by the user 104.

At operation 310, the computerized event platform 102 (e.g., the event engine 116 thereof) may, optionally, use a computerized model trained for generating the set of recommended participants to generate bid vectors from the various participants 112A, 112B, 112N. The model may be trained using participant data 126. In some examples, the model is the same model trained to generate the set of recommended participants, as described herein. In other examples, the model is similar to the model used to generate the set of recommended participants, but including input features describing aspects of the participants' received bids including, for example, item price, total price, bid terms, etc. The model may be a CNN model and may be trained as an autoencoder, as described herein.

At operation 310, the computerized event platform 102 (e.g., the event engine 116 thereof) utilizes the model to generate bid vectors for the participants 112A, 112B, 112N who submitted bids. The bid vectors may be determined, for example, utilizing coefficients from nodes of an intermediate layer of the model, as described herein. At operation 312, the computerized event platform 102 (e.g., the event engine 116 thereof) generates bid clusters in a multi-dimensional space using the bid vectors determined at operation 310. The clusters may be determined, for example, using k-means or any other suitable technique.

At operation 314, the computerized event platform 102 (e.g., the event engine 116 thereof) generates a bid recommendation indicating the bid or (or bids) that are most favorable for the user 104. This can include, for example, selecting the bid or bids that are closest to a cluster mean of the cluster of bid vectors indicating the highest value (e.g., the best bids). The bid recommendation may be sent to the user 104 or, in some examples, automatically accepted.

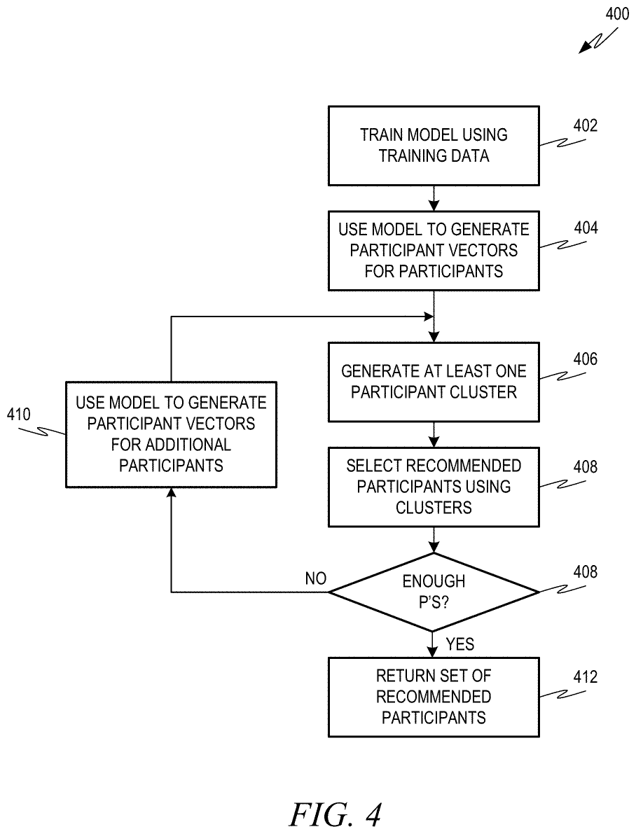

FIG. 4 is a flowchart showing an example of a process flow 400 that may be executed by the computerized event platform 102 (e.g., the participant recommendation engine 118 thereof) to determine a set of recommended participants. In the example of FIG. 4, the computerized event platform 102 (e.g., the participant recommendation engine 118 thereof) initially considers incumbent participants. If analysis of the incumbent participants fails to result in a set of recommended participants including a sufficient number of participants, then the computerized event platform 102 (e.g., the participant recommendation engine 118 thereof) determines a new set of recommended participants including non-incumbent participants.

At operation 402, the computerized event platform 102 (e.g., the participant recommendation engine 118 thereof) trains a model, for example, as described with respect to FIG. 2. At operation 404, the computerized event platform 102 (e.g., the participant recommendation engine 118 thereof) uses the model to generate participant vectors for a set of potential participants. Initially, the participants under consideration may be limited to incumbent participants. At operation 406, the computerized event platform 102 (e.g., the participant recommendation engine 118 thereof) generates at least one participant cluster and at operation 408, the computerized event platform 102 (e.g., the participant recommendation engine 118 thereof) selects a set of recommended participants. Operations 406 and 408 may be performed, for example, as described herein with respect to FIG. 2.

At operation 408, the computerized event platform 102 (e.g., the participant recommendation engine 118 thereof) determines if the set of recommended participants determined at operation 408 includes a sufficient number of participants. A set of recommended participants may include a sufficient number of participants, for example, when the set of recommended participants is likely to return a sufficient number of bids. In some examples, the sufficient number of participants can be determined by considering historical comparisons between the total and lead bid in instances where there is 100% participation (e.g., all invited participants submit bid data) and instances where there is less than 100% participation. If, for the set of selected participants, the difference between the total and lead bids is less than a threshold from the difference between total and lead bids in events with 100% participation, then the set of recommended participants may include a sufficient number of participants.

If there is a sufficient number of participants in the set of recommended participants, the computerized event platform 102 (e.g., the participant recommendation engine 118 thereof) returns the set of recommended participants at operation 412. On the other hand, if the set of recommended participants at operation 408 is insufficient, the computerized event platform 102 (e.g., the participant recommendation engine 118 thereof) uses the model to generate participant vectors for at least some non-incumbent participants. The computerized event platform 102 (e.g., the participant recommendation engine 118 thereof) then proceeds to operation 406, using the participant vectors generated at operations 404 and 410 to generate participant clusters.

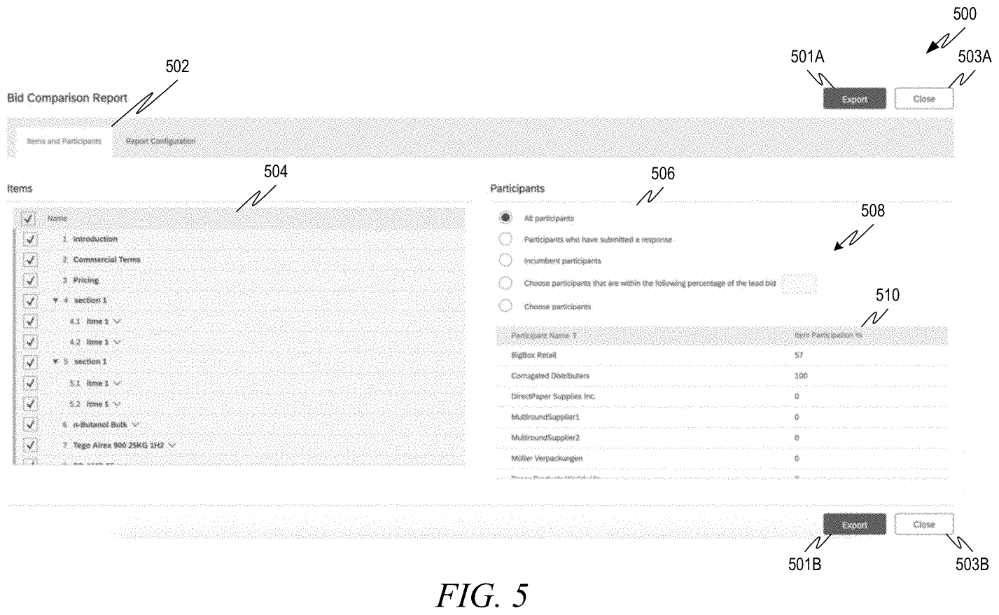

FIG. 5 is a screen shot showing one example of a screen 500 of a user interface that may be provided to the user 104 by the computerized event platform 102. The screen 500 may be displayed by selecting an Items and Participants tab 502. The screen 500 includes an Items field 504 and a Participants field 506. The Items field 504 lists items and terms to be included in an event. The user 104 may select (e.g., click on) one or more selections from the list of items and terms at the Items field 504 to modify items.

The Participants field 506 receives data from the user 104 regarding participants that are to be invited to participate in an event. A filter field 508 allows the user 104 to filter participants. Participants selected with the filter indicated at field 508 are displayed at a Participant Name field 508. The Participant Name field 510 displays names for participants and an Item Participation % indicating the percent of items in the event for which the participant has submitted a bid. In some examples, the participants selected with the filter selected at field 508 are provided to the computerized event platform 102 as a set of participants to be invited to an event. In other examples, the participants selected with the filter indicated at field 508 are provided as the set of potential participants considered by the participant recommendation engine.

In the example of FIG. 5, the user 104 has selected an “All participants” filter that causes the Participant Name Field 508 to display all available participants. A “Participants who have submitted a response” filter may be selected during an event to display only participants who have already submitted bid data. An “Incumbent participant” filter may be selected to display only incumbent participants. A “Choose participants that are within the following percentage of the lead bid” field allows the user 104 to select a threshold to filter out participants who are not within the selected percentage of the lead bid type. A “Choose participants” filter may allow the user 104 to select participants, for example, by name.

The screen 500 includes Export buttons 501A, 501B and Close buttons 503A, 503B. The user 104 may select one of the Export buttons 501A, 501B to export data provided through the screen (e.g., filter selections, term information, etc.) to the computerized event platform 102. The user 104 may select one of the buttons 503A, 503B to close the screen 500.

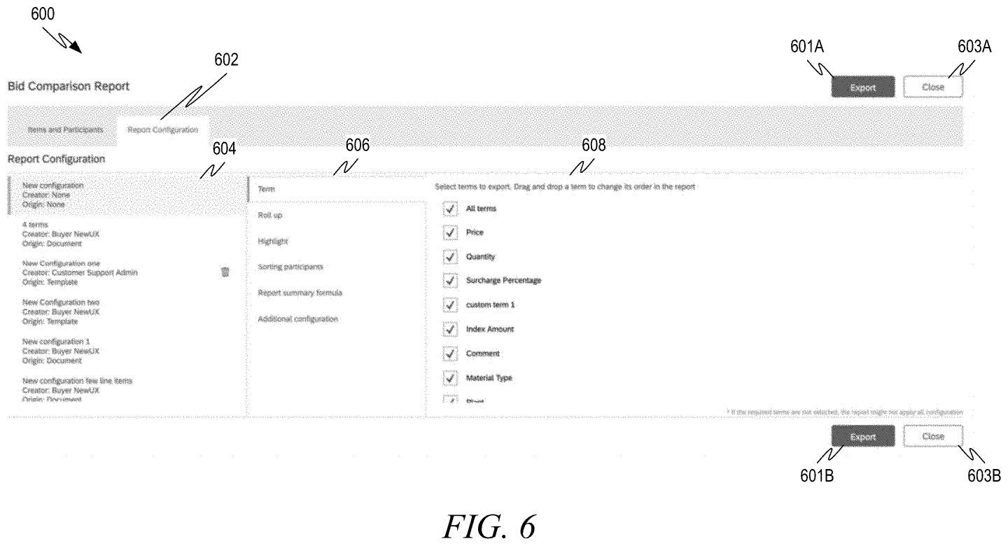

FIG. 6 is a screen shot showing one example of a screen 600 of a user interface that may be provided to the user 104 by the computerized event platform 102. The screen 600 may be displayed with a Report Configuration tab 602 is selected by the user 104. A report list field 604 includes a list of report configurations that may be selected for editing. A report configuration can include a format for receiving reports from the computerized event platform 102. The reports can include reports indicating recommended participants, reports indicating bids received from invited participants, etc. Field 606 includes report feature types that can be selected by the user 104 for modification. In the example of FIG. 6, a “Term” feature type is selected. Term options are displayed at a term window 608. The user can select a term for inclusion in an action at the term window 608 and/or order the terms to select the order that the terms appear in a report.

The screen 600 also includes Export buttons 601A, 601B and Close buttons 603A, 603B. The user 104 may select one of the Export buttons 601A, 601B to export data provided through the screen (e.g., report configurations) to the computerized event platform 102. The user 104 may select one of the buttons 603A, 603B to close the screen 600.

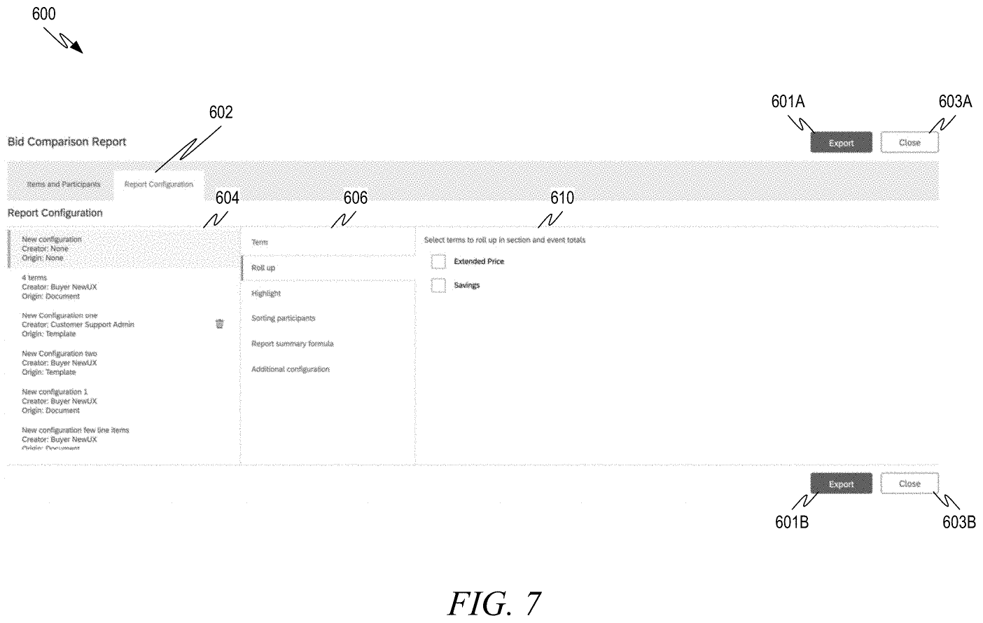

FIG. 7 is a screen shot showing another example of the screen 600 with a “Roll Up” feature selected at the field 606. At a roll up selection field 610, the user 104 can select terms that are rolled up or presented in a summarized format in a final report. In this example, the user can select to roll up reports by extended price and/or by price savings. Rolling up a report may include getting the total price and quantity for an item over multiple offerings, for example, to allow the user to engage in volume-based negotiations.

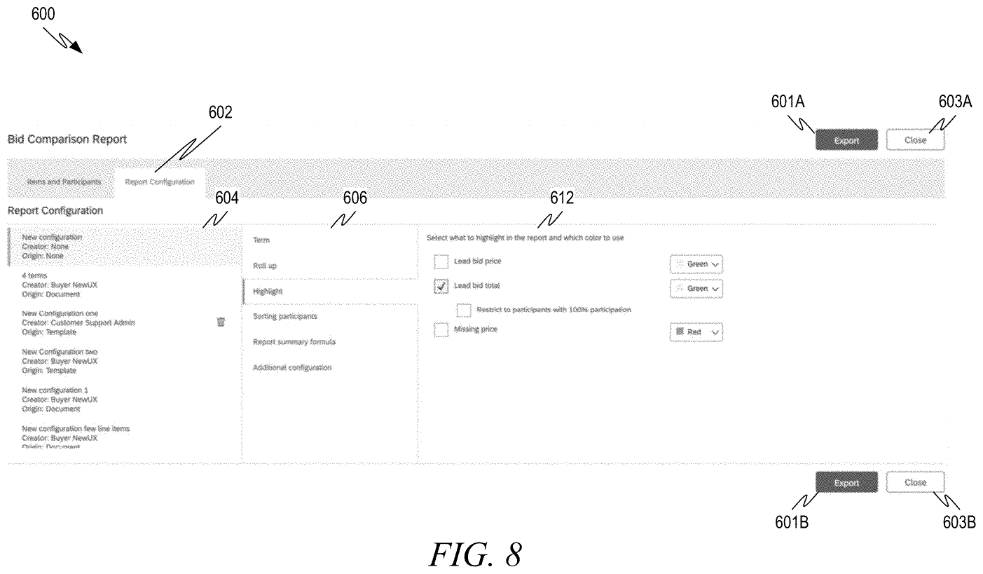

FIG. 8 is a screen shot showing another example of the screen 600 with a “Highlight” feature selected at the field 606. A highlight selection field 612 provides the user 104 with features to select report fields (e.g., Lead bid price, Lead bid total, Missing price) and have the selected fields highlighted in a format, such as a color, selected by the user.

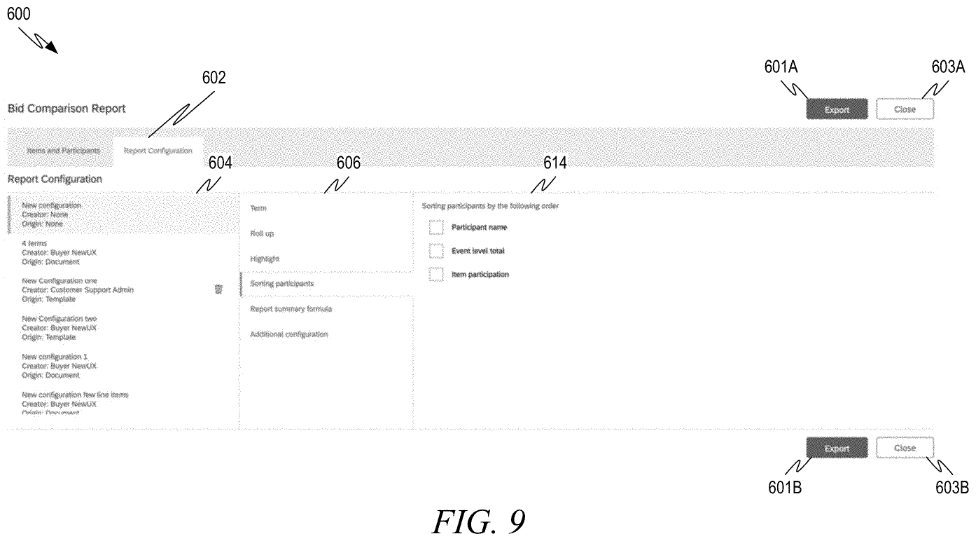

FIG. 9 is a screen shot showing another example of the screen 600 with a “Sorting participants” feature selected at the field 606. A sorting field 614 provides the user 104 with features to select an order in which participants will be listed in the report. In the example of FIG. 9, the user 104 may select to sort participants by participant name, by item participation (e.g., the number of items in the event that the participant has bid on), and/or by event level total indicating the total bid by the participant for the event.

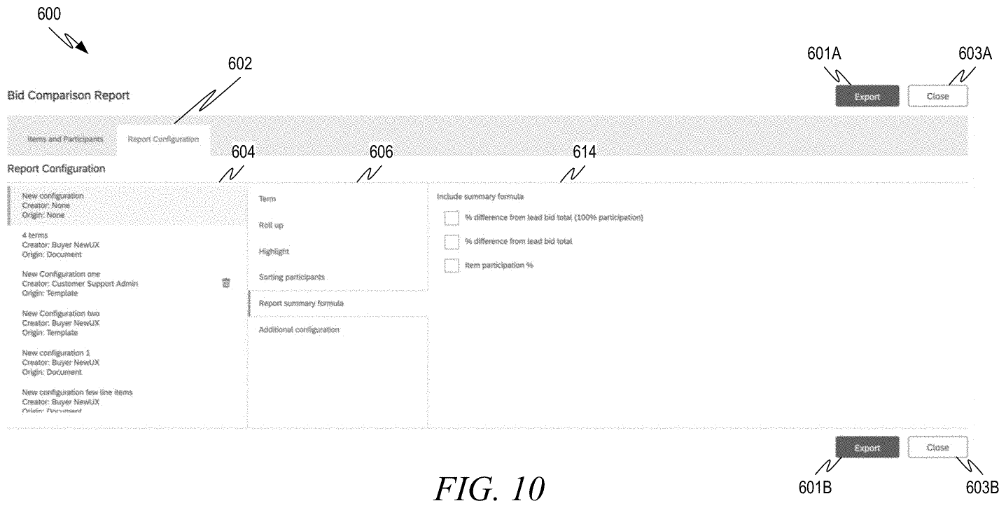

FIG. 10 is a screen shot showing another example of the screen 600 with a “Report Summary formula” feature selected at the field 606. A summary formula field 614 is displayed and permits the user to select a methodology that can be used by the computerized event platform 102 to summarize a report. For example, if the report indicates a set of recommended participants, the methodology for summarizing the report may indicate how a summary of the set will be generated for the report. In examples where the report indicates the results of an event, the methodology for summarizing the report may indicate how a summary of the received bids will be generated for the report.

In the example of FIG. 10, the user 104 may select a summarizing methodology that summarizes participants based on a percentage difference from the lead bid total, assuming 100% participation, a percentage difference from the lead bit total, or an item participation percentage.

### Examples

Example 1 is a system for managing a computerized event, the system comprising: a computerized event platform comprising at least one processor programmed to perform operations comprising: receiving participant data describing a plurality of historical interactions from a plurality of historical events; using the participant data to train a model, wherein the model is configured to receive a set of features describing a participant and to generate a participant vector, the set of features comprising at least one participant engagement feature describing a response of the participant to a previous invitation to participate in an event; using the model to generate a first participant vector for a first participant and a first item; using the model to generate a second participant vector for a second participant; generating at least one participant vector cluster using a plurality of participant vectors, the plurality of participant vectors comprising the first participant vector and the second participant vector; selecting a set of participant vectors that are within a threshold distance of a first cluster mean in a first multi-dimensional space; using the set of participant vectors to select a set of recommended participants for an event to provide the first item; inviting at least a portion of the set of recommended participants to participate in the event to provide the first item; and receiving current interaction proposal data from at least a portion of the invited participants; and selecting, using the current interaction proposal data, a winning participant recommendation.

In Example 2, the subject matter of Example 1 optionally includes wherein the set of features comprises at least one lead price feature based at least in part on a price associated with a previous interaction by a participant in a previous event and a winning price for the previous event.

In Example 3, the subject matter of any one or more of Examples 1-2 optionally includes wherein the model comprises a convolutional neural network model.

In Example 4, the subject matter of any one or more of Examples 1-3 optionally includes wherein the model comprises a neural network model to generate the plurality of participant vectors.

In Example 5, the subject matter of any one or more of Examples 1-4 optionally includes wherein generating the at least one participant vector cluster comprises applying a clustering algorithm to the plurality of participant vectors.

In Example 6, the subject matter of any one or more of Examples 1-5 optionally includes the operations further comprising: using the model to generate a third participant vector for a third participant, wherein the third participant is an invited participant, and wherein at least a portion of the current interaction proposal data is received from the third participant; using the model to generate a fourth participant vector for a fourth participant, wherein the fourth participant is an invited participant, and wherein at least a portion of the current interaction proposal data is received from the fourth participant; and generating the winning participant recommendation using the third participant vector and the fourth participant vector.

In Example 7, the subject matter of Example 6 optionally includes the operations further comprising generating at least one participant vector cluster using the third participant vector and the fourth participant vector, wherein the generating of the winning participant recommendation is based at least in part on a distance between the third participant vector and a second cluster mean in a second multi-dimensional space.

Example 8 is a method of managing a computerized event platform, the method comprising: receiving participant data describing a plurality of historical interactions from a plurality of historical events; using the participant data to train a model, wherein the model is configured to receive a set of features describing a participant and to generate a participant vector, the set of features comprising at least one participant engagement feature describing a response of the participant to a previous invitation to participate in an event; using the model to generate a first participant vector for a first participant and a first item; using the model to generate a second participant vector for a second participant; generating at least one participant vector cluster using a plurality of participant vectors, the plurality of participant vectors comprising the first participant vector and the second participant vector; selecting a set of participant vectors that are within a threshold distance of a first cluster mean in a first multi-dimensional space; using the set of participant vectors to select a set of recommended participants for an event to provide the first item; inviting at least a portion of the set of recommended participants to participate in the event to provide the first item; and receiving current interaction proposal data from at least a portion of the invited participants; and selecting, using the current interaction proposal data, a winning participant recommendation.

In Example 9, the subject matter of Example 8 optionally includes wherein the set of features comprises at least one lead price feature based at least in part on a price associated with a previous interaction by a participant in a previous event and a winning price for the previous event.

In Example 10, the subject matter of any one or more of Examples 8-9 optionally includes wherein the model comprises a convolutional neural network model.

In Example 11, the subject matter of any one or more of Examples 8-10 optionally includes wherein the model comprises a neural network model to generate the plurality of participant vectors.

In Example 12, the subject matter of any one or more of Examples 8-11 optionally includes wherein generating the at least one participant vector cluster comprises applying a clustering algorithm to the plurality of participant vectors.

In Example 13, the subject matter of any one or more of Examples 8-12 optionally includes using the model to generate a third participant vector for a third participant, wherein the third participant is an invited participant, and wherein at least a portion of the current interaction proposal data is received from the third participant; using the model to generate a fourth participant vector for a fourth participant, wherein the fourth participant is an invited participant, and wherein at least a portion of the current interaction proposal data is received from the fourth participant; and generating the winning participant recommendation using the third participant vector and the fourth participant vector.

In Example 14, the subject matter of Example 13 optionally includes generating at least one participant vector cluster using the third participant vector and the fourth participant vector, wherein the generating of the winning participant recommendation is based at least in part on a distance between the third participant vector and a second cluster mean in a second multi-dimensional space.

Example 15 is a machine-readable medium having instructions thereon that, when executed by at least one processor, cause the at least one processor to perform operations comprising: receiving participant data describing a plurality of historical interactions from a plurality of historical events; using the participant data to train a model, wherein the model is configured to receive a set of features describing a participant and to generate a participant vector, the set of features comprising at least one participant engagement feature describing a response of the participant to a previous invitation to participate in an event; using the model to generate a first participant vector for a first participant and a first item; using the model to generate a second participant vector for a second participant; generating at least one participant vector cluster using a plurality of participant vectors, the plurality of participant vectors comprising the first participant vector and the second participant vector; selecting a set of participant vectors that are within a threshold distance of a first cluster mean in a first multi-dimensional space; using the set of participant vectors to select a set of recommended participants for an event to provide the first item; inviting at least a portion of the set of recommended participants to participate in the event to provide the first item; and receiving current interaction proposal data from at least a portion of the invited participants; and selecting, using the current interaction proposal data, a winning participant recommendation.

In Example 16, the subject matter of Example 15 optionally includes wherein the set of features comprises at least one lead price feature based at least in part on a price associated with a previous interaction by a participant in a previous event and a winning price for the previous event.

In Example 17, the subject matter of any one or more of Examples 15-16 optionally includes wherein the model comprises a convolutional neural network model.

In Example 18, the subject matter of any one or more of Examples 15-17 optionally includes wherein the model comprises a neural network model to generate the plurality of participant vectors.

In Example 19, the subject matter of any one or more of Examples 15-18 optionally includes wherein generating the at least one participant vector cluster comprises applying a clustering algorithm to the plurality of participant vectors.

In Example 20, the subject matter of any one or more of Examples 15-19 optionally includes the operations further comprising: using the model to generate a third participant vector for a third participant, wherein the third participant is an invited participant, and wherein at least a portion of the current interaction proposal data is received from the third participant; using the model to generate a fourth participant vector for a fourth participant, wherein the fourth participant is an invited participant, and wherein at least a portion of the current interaction proposal data is received from the fourth participant; and generating the winning participant recommendation using the third participant vector and the fourth participant vector.

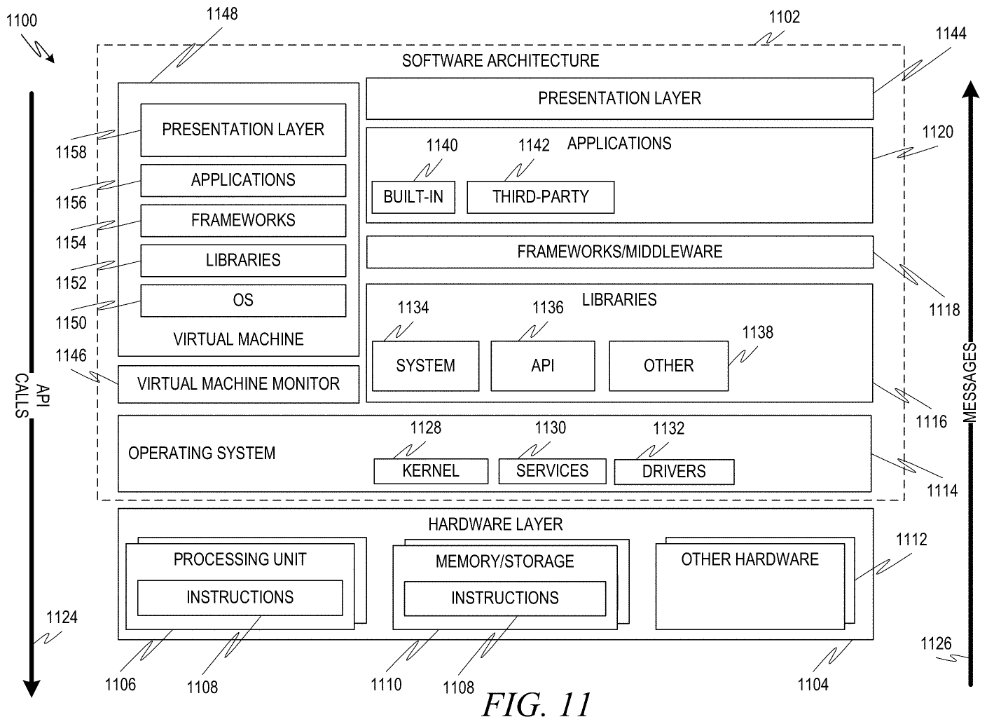

FIG. 11 is a block diagram 1100 showing one example of a software architecture 1102 for a computing device. The architecture 1102 may be used in conjunction with various hardware architectures, for example, as described herein. FIG. 11 is merely a non-limiting example of a software architecture and many other architectures may be implemented to facilitate the functionality described herein. A representative hardware layer 1104 is illustrated and can represent, for example, any of the above referenced computing devices. In some examples, the hardware layer 1104 may be implemented according to the architecture of the computer system of FIG. 11.

The representative hardware layer 1104 comprises one or more processing units 1106 having associated executable instructions 1108. Executable instructions 1108 represent the executable instructions of the software architecture 1102, including implementation of the methods, modules, subsystems, and components, and so forth described herein and may also include memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of the software architecture 1102.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120 and presentation layer 1144. Operationally, the applications 1120 and/or other components within the layers may invoke application programming interface (API) calls 1124 through the software stack and access a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of an interrupt and, in response, cause the architecture 1102 to pause its current processing and execute an interrupt service routine (ISR) when an interrupt is accessed.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be utilized by the applications 1120 and/or other software components/modules. For example, the frameworks 1118 may provide various graphic user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a contacts application, a browser application, a book reader application, a location application, a media application, a messaging application, and/or a game application. Third-party applications 1142 may include any of the built in applications as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1142 may invoke the API calls 1124 provided by the mobile operating system such as operating system 1114 to facilitate functionality described herein.

The applications 1120 may utilize built in operating system functions (e.g., kernel 1128, services 1130 and/or drivers 1132), libraries (e.g., system 1134, APIs 1136, and other libraries 1138), frameworks/middleware 1118 to create user interfaces to interact with users of the system. Alternatively, or additionally, in some systems interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware computing device. A virtual machine is hosted by a host operating system (operating system 1114) and typically, although not always, has a virtual machine monitor 1146, which manages the operation of the virtual machine as well as the interface with the host operating system (i.e., operating system 1114). A software architecture executes within the virtual machine 1148 such as an operating system 1150, libraries 1152, frameworks/middleware 1154, applications 1156 and/or presentation layer 1158. These layers of software architecture executing within the virtual machine 1148 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

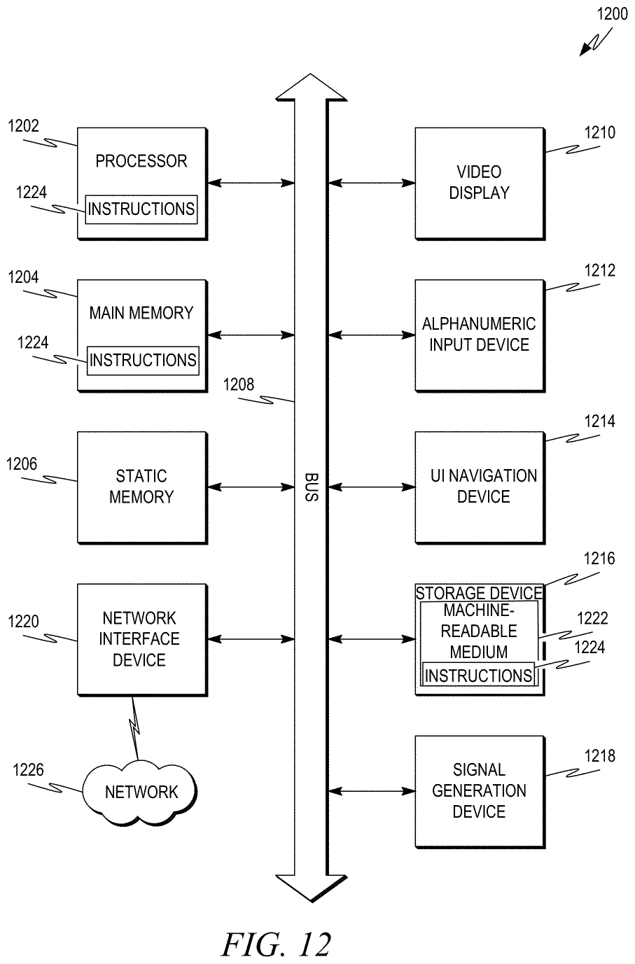

FIG. 12 is a block diagram of a machine in the example form of a computer system 1200 within which instructions 1224 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation (or cursor control) device 1214 (e.g., a mouse), a disk drive unit 1216, a signal generation device 1218 (e.g., a speaker), and a network interface device 1220.

### Machine-Readable Medium

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, with the main memory 1204 and the processor 1202 also constituting machine-readable media 1222.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding, or carrying instructions 1224 for execution by the machine and that cause the machine to perform any one or more of the methodologies of the present disclosure, or that is capable of storing, encoding, or carrying data structures utilized by or associated with such instructions 1224. The term “machine-readable medium” shall accordingly be taken to include, but not be limited to, solid-state memories, and optical and magnetic media. Specific examples of machine-readable media 1222 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. A machine-readable medium is not a transmission medium.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1224 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for managing a computerized event, the system comprising:
a computerized event platform comprising at least one processor programmed to perform operations comprising:
receiving participant data describing a plurality of historical interactions from a plurality of historical events;
using the participant data to train a model, wherein the model is configured to receive a set of features describing a participant and to generate a participant vector, the set of features comprising at least one participant engagement feature describing a response of the participant to a previous invitation to participate in an event;
using the model to generate a first participant vector for a first participant and a first item;
using the model to generate a second participant vector for a second participant;
generating at least one participant vector cluster using a plurality of participant vectors, the plurality of participant vectors comprising the first participant vector and the second participant vector;
selecting a set of participant vectors that are within a threshold distance of a first cluster mean in a first multi-dimensional space;
using the set of participant vectors to select a set of recommended participants for an event to provide the first item;
inviting at least a portion of the set of recommended participants to participate in the event to provide the first item; and
receiving current interaction proposal data from at least a portion of the invited participants; and
selecting, using the current interaction proposal data, a winning participant recommendation.

2. The system of claim 1, wherein the set of features comprises at least one lead price feature based at least in part on a price associated with a previous interaction by a participant in a previous event and a winning price for the previous event.

3. The system of claim 1, wherein the model comprises a convolutional neural network model.

4. The system of claim 1, wherein the model comprises a neural network model to generate the plurality of participant vectors.

5. The system of claim 1, wherein generating the at least one participant vector cluster comprises applying a clustering algorithm to the plurality of participant vectors.

6. The system of claim 1, the operations further comprising:
using the model to generate a third participant vector for a third participant, wherein the third participant is an invited participant, and wherein at least a portion of the current interaction proposal data is received from the third participant;
using the model to generate a fourth participant vector for a fourth participant, wherein the fourth participant is an invited participant, and wherein at least a portion of the current interaction proposal data is received from the fourth participant; and
generating the winning participant recommendation using the third participant vector and the fourth participant vector.

7. The system of claim 6, the operations further comprising generating at least one participant vector cluster using the third participant vector and the fourth participant vector, wherein the generating of the winning participant recommendation is based at least in part on a distance between the third participant vector and a second cluster mean in a second multi-dimensional space.

8. A method of managing a computerized event platform, the method comprising:
receiving participant data describing a plurality of historical interactions from a plurality of historical events;
using the participant data to train a model, wherein the model is configured to receive a set of features describing a participant and to generate a participant vector, the set of features comprising at least one participant engagement feature describing a response of the participant to a previous invitation to participate in an event;
using the model to generate a first participant vector for a first participant and a first item;
using the model to generate a second participant vector for a second participant;
generating at least one participant vector cluster using a plurality of participant vectors, the plurality of participant vectors comprising the first participant vector and the second participant vector;
selecting a set of participant vectors that are within a threshold distance of a first cluster mean in a first multi-dimensional space;
using the set of participant vectors to select a set of recommended participants for an event to provide the first item;
inviting at least a portion of the set of recommended participants to participate in the event to provide the first item; and
receiving current interaction proposal data from at least a portion of the invited participants; and
selecting, using the current interaction proposal data, a winning participant recommendation.

9. The method of claim 8, wherein the set of features comprises at least one lead price feature based at least in part on a price associated with a previous interaction by a participant in a previous event and a winning price for the previous event.

10. The method of claim 8, wherein the model comprises a convolutional neural network model.

11. The method of claim 8, wherein the model comprises a neural network model to generate the plurality of participant vectors.

12. The method of claim 8, wherein generating the at least one participant vector cluster comprises applying a clustering algorithm to the plurality of participant vectors.

13. The method of claim 8, further comprising:
using the model to generate a third participant vector for a third participant, wherein the third participant is an invited participant, and wherein at least a portion of the current interaction proposal data is received from the third participant;
using the model to generate a fourth participant vector for a fourth participant, wherein the fourth participant is an invited participant, and wherein at least a portion of the current interaction proposal data is received from the fourth participant; and
generating the winning participant recommendation using the third participant vector and the fourth participant vector.

14. The method of claim 13, further comprising generating at least one participant vector cluster using the third participant vector and the fourth participant vector, wherein the generating of the winning participant recommendation is based at least in part on a distance between the third participant vector and a second cluster mean in a second multi-dimensional space.

15. A machine-readable medium having instructions thereon that, when executed by at least one processor, cause the at least one processor to perform operations comprising:
receiving participant data describing a plurality of historical interactions from a plurality of historical events;
using the participant data to train a model, wherein the model is configured to receive a set of features describing a participant and to generate a participant vector, the set of features comprising at least one participant engagement feature describing a response of the participant to a previous invitation to participate in an event;
using the model to generate a first participant vector for a first participant and a first item;
using the model to generate a second participant vector for a second participant;
generating at least one participant vector cluster using a plurality of participant vectors, the plurality of participant vectors comprising the first participant vector and the second participant vector;
selecting a set of participant vectors that are within a threshold distance of a first cluster mean in a first multi-dimensional space;
using the set of participant vectors to select a set of recommended participants for an event to provide the first item;
inviting at least a portion of the set of recommended participants to participate in the event to provide the first item; and
receiving current interaction proposal data from at least a portion of the invited participants; and
selecting, using the current interaction proposal data, a winning participant recommendation.

16. The medium of claim 15, wherein the set of features comprises at least one lead price feature based at least in part on a price associated with a previous interaction by a participant in a previous event and a winning price for the previous event.

17. The medium of claim 15, wherein the model comprises a convolutional neural network model.

18. The medium of claim 15, wherein the model comprises a neural network model to generate the plurality of participant vectors.

19. The medium of claim 15, wherein generating the at least one participant vector cluster comprises applying a clustering algorithm to the plurality of participant vectors.

20. The medium of claim 15, the operations further comprising:
using the model to generate a third participant vector for a third participant, wherein the third participant is an invited participant, and wherein at least a portion of the current interaction proposal data is received from the third participant;
using the model to generate a fourth participant vector for a fourth participant, wherein the fourth participant is an invited participant, and wherein at least a portion of the current interaction proposal data is received from the fourth participant; and
generating the winning participant recommendation using the third participant vector and the fourth participant vector.
